(19) United States
(12) Patent Application Publication
(10) Pub. No.: US 2023/0133925 A1
(43) Pub. Date: May 4, 2023

(54) WIRELESS COMMUNICATION DEVICE AND METHOD

(71) Applicant: INSTITUTE FOR INFORMATION INDUSTRY, TAIPEI (TW)

(72) Inventors: Wei Zhih LIN, Taipei (TW); Cong Xiang WANG, Taipei (TW); Hsiang-Ju LU, Taipei (TW)

(21) Appl. No.: 17/456,553

(22) Filed: Nov. 24, 2021

(30) Foreign Application Priority Data
Oct. 29, 2021 (TW) 110140478

(51) Int. Cl. H04W 28/02; H04L 12/859; H04L 12/851; H04W 80/12; H04W 76/15

(52) U.S. Cl. CPC H04W 28/0268; H04L 47/2475; H04L 47/2483; H04W 80/12; H04W 76/15

(57) ABSTRACT

A wireless communication device is provided, which includes a transceiver circuit and a processor. The processor is configured to execute operations of: by an application layer, generating a packet, and generating a topic name of the packet and a priority order corresponding to the packet according to the packet; by the application layer, generating a port number according to the priority order and the first quality of service correspondence table, and establishing a first setting table to store corresponding relationship between the port number and the topic name; by a middleware layer, receiving the topic name from the application layer, and searching the corresponding port number by looking up the first setting table according to the topic name; and by the middleware layer, establishing a first communication connection from the wireless communication device to the base station according to the port number.

### CROSS-REFERENCE TO RELATED APPLICATION

This application claims priority to Taiwan Application Ser. No. 110140478, filed Oct. 29, 2021, which is herein incorporated by reference in its entirety.

### BACKGROUND

### Field of Disclosure

The present disclosure relates to a wireless communication device and method.

### Description of Related Art

In a current communication network, when a middleware layer performing under an application layer based on a communication protocol, if a packet in this middleware layer does not have a complete quality of service (QoS) identifier, this will cause the packet to fail to be transmitted according to a specified QoS channel when the packet is transmitted to a transport layer. Therefore, this will cause a result that the transmission cannot be performed according to characteristics of the priority order of the packet.

### SUMMARY

The disclosure provides a wireless communication device, which includes a transceiver circuit and a processor. A transceiver circuit is configured for receiving a first quality of service correspondence table from a base station. A processor is connected to the transceiver circuit, where the processor is configured to execute operations of: by an application layer, generating a packet, and generating a topic name of the packet and a priority order corresponding to the packet according to the packet; by the application layer, generating a port number according to the priority order and the first quality of service correspondence table, and establishing a first setting table to store corresponding relationship between the port number and the topic name; by a middleware layer, receiving the topic name from the application layer, and searching the corresponding port number by looking up the first setting table according to the topic name; and by the middleware layer, establishing a first communication connection from the wireless communication device to the base station according to the port number, and transmitting the packet from the wireless communication device to the base station through the first communication connection.

The disclosure provides a wireless communication method, which includes following steps: receiving a first quality of service correspondence table from a base station; by an application layer, generating a packet, and generating a topic name of the packet and a priority order corresponding to the packet according to the packet; by the application layer, generating a port number according to the priority order and the first quality of service correspondence table, and establishing a first setting table to store corresponding relationship between the port number and the topic name; by a middleware layer, receiving the topic name from the application layer, and searching the corresponding port number by looking up the first setting table according to the topic name; and by the middleware layer, establishing a first communication connection from the wireless communication device to the base station according to the port number, and transmitting the packet from the wireless communication device to the base station through the first communication connection.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a wireless communication device of the disclosure.

FIG. 2 is a flowchart of a wireless communication method of the disclosure.

FIG. 3 is a schematic diagram of establishing a communication connection according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

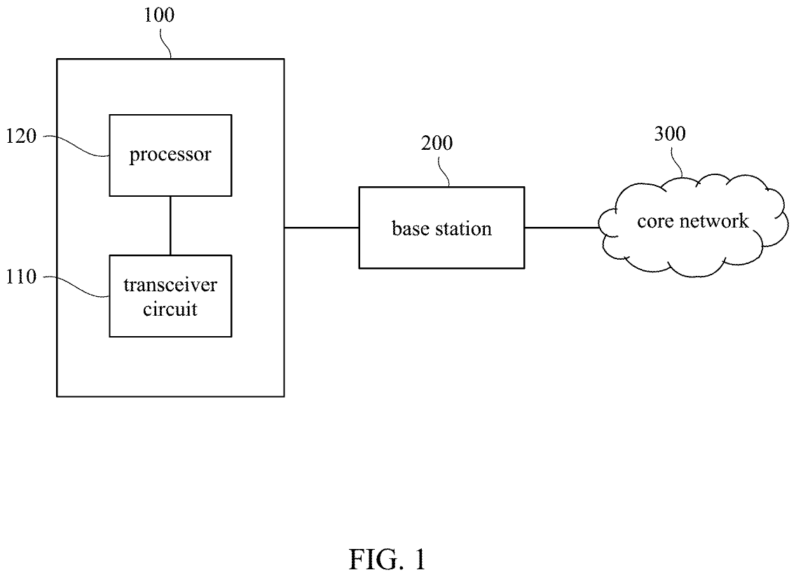

Reference is made to FIG. 1, which is a block diagram of a wireless communication device 100 of the disclosure. In an embodiment, the wireless communication device 100 includes a transceiver circuit 110 and a processor 120. The transceiver circuit 110 and the processor 120 are connected to each other.

In some embodiments, the wireless communication device 100 can be implemented by a computer, a server, or a processing center. In some embodiments, the transceiver circuit 110 can be a communication module for communicating with other devices or systems. In some embodiments, the processor 120 can be implemented by a processing unit, a central processing unit, or a computing unit. In some embodiments, the processor 120 can establish a communication connection with a base station 200 through an application layer, a middleware layer, and a transport layer.

In some embodiments, the wireless communication device 100 includes, but is not limited to, the transceiver circuit 110 and the processor 120, and the wireless communication device 100 can further include other components equipped to process required operations and applications. For example, the wireless communication device 100 can further include an output interface (e.g., a display panel for displaying information) and an input interface (e.g., a touch panel, a keyboard, a microphone, a scanner, or a flash memory reader).

In some embodiments, the wireless communication device 100 can be connected to a core network 300 through the base station 200. In some embodiments, the base station 200 can be an evolved node B (eNB) of the fourth generation of phone mobile communication technology (4G) or a next generation node B (gNB) of the fifth generation mobile networks (5G), etc. In some embodiments, the core network 300 can be evolved packet core (EPC) networks or next generation core (NGC) networks, etc.

In some embodiments, the wireless communication device 100 and method thereof of the disclosure can be applied to a data distribution service (DDS) or any communication mechanism architecture which applies to a cloud event transmission service (e.g., the publisher/subscriber mode).

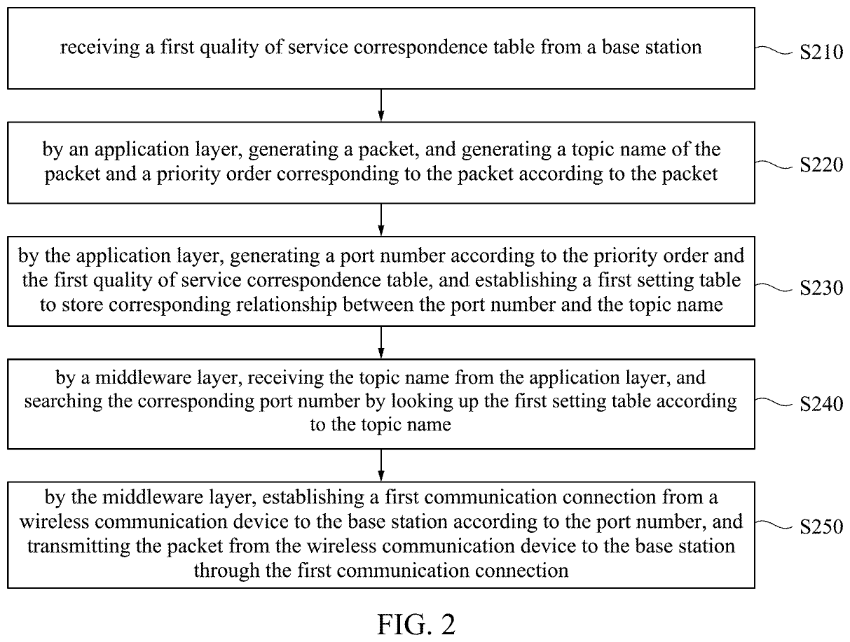

Reference is made to FIG. 2, which is a flowchart of a wireless communication method of the disclosure. The method of the embodiment shown in FIG. 2 is applicable to the wireless communication device 100 in FIG. 1, but is not limited herein. For the sake of convenience and clarity description, referring to FIGS. 1 and 2 at the same time in the following, detailed steps of the wireless communication method shown in FIG. 2 will be described with operation relationship between the components in the wireless communication device 100.

In an embodiment, the wireless communication method includes steps S210 to S240. First, in step S210, a first quality of service (QoS) correspondence table is received from the base station 200. In some embodiments, the first QoS correspondence table can be received from the base station 200 through the transceiver circuit 110, where the first Qos correspondence table can store corresponding relationship between multiple candidate port numbers and multiple candidate QoS profiles. In some embodiments, the candidate QoS profile may include a QoS class identity (QCI) and a corresponding priority.

It should be noted that the core network 300 can store the first QoS correspondence table to update the first QoS correspondence table periodically or non-periodically, and transmit the updated first QoS correspondence table to the wireless communication device 100 through the base station 200.

Furthermore, in step S220, by the application layer, a packet is generated, and a topic name of the packet and a priority order corresponding to the packet are generated according to the packet. In some embodiments, the topic name of the packet and the priority order corresponding to the packet can be set according to a type of the packet, where the topic name of the packet and the priority order corresponding to the packet are set by a user according to the type of the packet. For example, when the type of the packet is conversational voice, the packet needs to be transmitted to the core network 300 in real time. Therefore, the processor 120 can customize the topic name of the packet to be “high1”, and set the priority order of the packet to be “highest”.

Furthermore, in step S230, by the application layer, a port number is generated according to the priority order and the first QoS correspondence table, and a first setting table is established to store corresponding relationship between the port number and the topic name. In some embodiments, by the application layer, the first setting table can be transmitted to the middleware layer. In some embodiments, by the application layer, the first QoS correspondence table can be looked up according to the priority order to select the port number and the first QoS profile which correspond to the packet. For example, when the priority order corresponding to the packet is “highest”, the first QoS correspondence table can be looked up to select the candidate QoS profile with a highest priority, and the candidate port number corresponding to this candidate QoS profile is used as the port number corresponding to the packet, so that this candidate QoS profile is used as the first QoS profile corresponding to the packet.

Furthermore, in step S240, by the middleware layer, the topic name is received from the application layer, and the corresponding port number is searched by looking up the first setting table according to the topic name. Furthermore, in step S250, by the middleware layer, a first communication connection is established from the wireless communication device 100 to the base station 200 according to the port number, and the packet is transmitted from the wireless communication device 100 to the base station 200 through the first communication connection. In some embodiments, by the middleware layer, the first communication connection from the wireless communication device 100 to the base station 200 can be established according to the port number, where the first communication connection with the port number adopts the first QoS profile. In some embodiments, the first communication connection can be a wireless communication connection of evolved packet system bearer (EPS Bearer) corresponding to the first QoS profile.

In other words, as long as the middleware layer can find the required port number from the first setting table according to the topic name received from the application layer, a wireless channel of the EPS bearer system from the wireless communication device 100 to the base station 200 can be established according to the port number through the transport layer, where the wireless channel corresponds to the selected first QoS profile. Therefore, it will be possible to set different wireless bearers for different packets.

In some optional embodiments, a second QoS correspondence table can be received from the base station 200 through the transceiver circuit 110. Then, by the application layer, a type of service (ToS) tag is generated according to the priority order and the second QoS correspondence table, and a second setting table is established to store correspondence relationship between the ToS tag, the port number, and the topic name. Then, by the middleware layer, the topic name is received from the application layer, and the second setting table is looked up according to the topic name to search the corresponding ToS tag. Then, by the middleware layer, a second communication connection is established from the wireless communication device 100 to the base station 200 according to the ToS tag, and the packet is transmitted from the wireless communication device 100 to the base station 200 through the second communication connection.

It should be noted that the core network 300 can store the second QoS correspondence table to update the second QoS correspondence table periodically or non-periodically, and transmit the updated second QoS correspondence table to the wireless communication device 100 through the base station 200.

In some optional embodiments, the second QoS correspondence table stores corresponding relationship between multiple candidate ToS tags and the multiple candidate QoS profiles. In some optional embodiments, by the application layer, the second QoS correspondence table is looked up according to the priority order to select the ToS tag and a second QoS profile which correspond to the packet. For example, when the priority order corresponding to the packet is “the highest”, the second QoS correspondence table can be looked up to select the candidate QoS profile with the highest priority, and the candidate ToS tag corresponding to this candidate QoS profile is used as the ToS tag corresponding to the packet, so that this candidate QoS profile is used as the second QoS profile corresponding to the packet.

In some optional embodiments, by the middleware layer, the second communication connection from the wireless communication device 100 to the base station 200 can be established through the ToS tag, where the second communication connection with the port number adopts the second QoS profile. In some optional embodiments, the second communication connection can be a wireless communication connection of a QoS flow corresponding to the second QoS profile.

In other words, as long as the middleware layer can find the required port number and the ToS tag from the second setting table according to the topic name received from the application layer, a wireless channel for the QoS flow from the wireless communication device 100 to the base station 200 can be established according to the ToS tag through the transport layer, where the wireless channel corresponds to the above-mentioned selected second QoS profile. Therefore, different QoS flows can be set for different packets in the same radio bearer, so as to allocate radio channel resources more efficiently.

Through the above-mentioned steps, since the packet sent by the application layer to the middleware layer may not carry the QoS identifier, in the case, the middleware layer can directly identify the corresponding port number or ToS tag according to the preset QoS correspondence table and the topic name received from the application layer. In this way, the QoS channel corresponding to the preset QoS profile (i.e., the above-mentioned first and second QoS profile) from the wireless communication device 100 to the base station 200 is established according to the port number or the ToS tag.

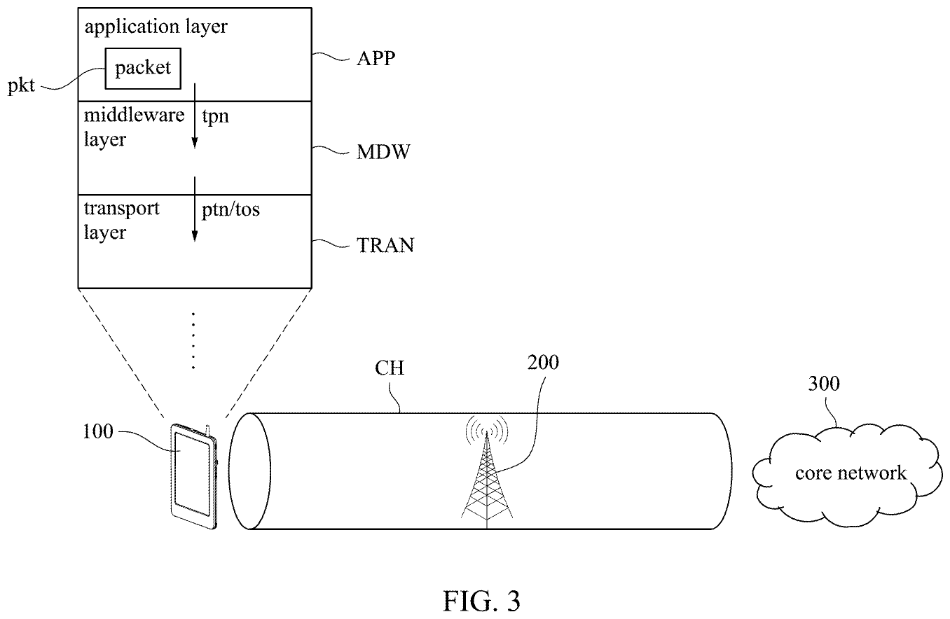

The above steps will be further explained below with actual examples. Reference is made to FIG. 3, which is a schematic diagram of establishing a communication connection according to some embodiments of the disclosure.

First, when the core network 300 is the EPC network, the core network 300 can store a first QoS correspondence table, and transmit the first QoS correspondence table to the wireless communication device 100.

Furthermore, in the wireless communication device 100, when the application layer APP generates a packet pkt to be transmitted, the application layer APP can identify a type of the packet pkt as an uploaded video, and identify that the packet pkt of the uploaded video can withstand a highest delay. In this way, the application layer APP can customize a topic name tpn of the packet pkt to “low1”, and set a priority order of the packet pkt to “the lowest”.

Furthermore, the application layer APP can look up the first QoS correspondence table to select a candidate QoS profile with a lowest priority, and use a candidate port number corresponding to this candidate QoS profile as a port number ptn corresponding to the packet pkt, so that this candidate QoS profile is used as a first QoS profile corresponding to the packet pkt. In this way, the application layer APP can establish a first setting table which stors corresponding relationship between the port number ptn and the topic name tpn. In other words, whenever a new packet is to be sent, the application layer APP can store a topic name of the new packet and a port number corresponding to the new packet in the first setting table.

Furthermore, the application layer APP can transmit the first setting table to the middleware layer MDW. Then, the application layer APP can transmit the topic name tpn to the middleware layer MDW, and the middleware layer MDW can search the port number ptn corresponding to the topic name tpn from the first setting table.

Furthermore, the middleware layer MDW can transmit the port number ptn to the transport layer TRAN, and the transport layer TRAN can use the port number ptn to establish a wireless transmission channel CH from the wireless communication device 100 to the base station 200 and the core network 300, where the wireless transmission channel CH is a channel of the EPS bearer corresponding to the first QoS profile.

Optionally, when the core network 300 is NGC networks, the core network 300 can store the second QoS correspondence table and transmit the second QoS correspondence table to the wireless communication device 100.

Furthermore, in the wireless communication device 100, when the application layer APP generates the packet pkt to be transmitted, the application layer APP can identify the type of the packet pkt as the uploaded video, and identify that the packet pkt of the uploaded video can withstand the higher latency. In this way, the application layer APP can label or modify the topic name tpn of the packet pkt (which is customized) with “low1”, and set the priority of the packet pkt to “the lowest”.

Furthermore, the application layer APP can look up the second QoS correspondence table to select the candidate QoS profile with the lowest priority, and use a candidate ToS tag corresponding to this candidate QoS profile as the ToS tag tos corresponding to the packet pkt, so that the candidate QoS profile is used as the second QoS profile corresponding to the packet pkt. In this way, the application layer APP can establish a second setting table which stores corresponding relationship between the ToS tag tos and the topic name tpn. In other words, whenever a new packet is to be transmitted, the application layer APP can store the topic name of the new packet and the ToS tag corresponding to the new packet in the second setting table.

Furthermore, the application layer APP can transmit the second setting table to the middleware layer MDW. Then, the application layer APP can transmit the topic name tpn to the middleware layer MDW, and the middleware layer MDW can search the ToS tag tos corresponding to the topic name tpn from the second setting table.

Furthermore, the middleware layer MDW can transmit the ToS tag tos to the transport layer TRAN, and the transport layer TRAN can use the ToS tag tos to establish a wireless transmission channel CH from the wireless communication device 100 to the base station 200 and the core network 300, where the wireless transmission channel CH is a channel of a QoS flow corresponding to the second QoS profile.

In summary, the wireless communication device and method of the embodiments of the disclosure can be used without modifying the existing wireless communication architecture (e.g., 4G, 5G communication) to let the middleware layer directly identify the port number based on the topic name of the packet by pre-setting the corresponding relationship between the topic name, the port number, and the QoS profile, so that the channel of QoS profile corresponding to the port number is established between the wireless communication device and the core network. In addition, by pre-setting the corresponding relationship between the topic name, the port number, the QoS profile, and the ToS tag, the middleware layer can directly identify the ToS tag based on the topic name of the packet, so that the channel of the QoS profile corresponding to the ToS tag is established between the wireless communication device and the core network. In this way, a problem that the packet cannot be transmitted according to a designated QoS channel caused when the packet in the middleware layer does not have a complete QoS identifier will be solved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless communication device, comprising:
a transceiver circuit, configured for receiving a first quality of service correspondence table from a base station; and
a processor, connected to the transceiver circuit, wherein the processor is configured to execute operations of:
by an application layer, generating a packet, and generating a topic name of the packet and a priority order corresponding to the packet according to the packet;
by the application layer, generating a port number according to the priority order and the first quality of service correspondence table, and establishing a first setting table to store corresponding relationship between the port number and the topic name;
by a middleware layer, receiving the topic name from the application layer, and searching the corresponding port number by looking up the first setting table according to the topic name; and
by the middleware layer, establishing a first communication connection from the wireless communication device to the base station according to the port number, and transmitting the packet from the wireless communication device to the base station through the first communication connection.

2. The wireless communication device of claim 1, wherein the processor is further configured to execute operations of:
by the application layer, looking up the first quality of service correspondence table according to the priority order to select the port number and a first quality of service profile which correspond to the packet.

3. The wireless communication device of claim 2, wherein the processor is further configured to execute operations of:
by the middleware layer, establishing the first communication connection from the wireless communication device to the base station through the port number, wherein the first communication connection with the port number adopts the first quality of service profile.

4. The wireless communication device of claim 1, wherein the processor is further configured to execute operations of:
by the transceiver circuit, receiving a second quality of service correspondence table from the base station;
by the application layer, generating a type of service tag according to the priority order and the second quality of service correspondence table, and establishing a second setting table to store corresponding relationship between the type of service tag, the port number, and the topic name;
by the middleware layer, receiving the topic name from the application layer, and searching the corresponding type of service tag by looking up the second setting table according to the topic name; and
by the middleware layer, establishing a second communication connection from the wireless communication device to the base station according to the type of service tag, and transmitting the packet from the wireless communication device to the base station through the second communication connection.

5. The wireless communication device of claim 4, wherein the processor is further configured to execute operations of:
by the application layer, looking up the second quality of service correspondence table according to the priority order to select the type of service tag and a second quality of service profile which correspond to the packet.

6. The wireless communication device of claim 5, wherein the processor is further configured to execute operations of:
by the middleware layer, establishing the second communication connection from the wireless communication device to the base station through the type of service tag, wherein the second communication connection with the port number adopts the second quality of service profile.

7. The wireless communication device of claim 4, wherein the first quality of service correspondence table stores corresponding relationship between a plurality of candidate port numbers and a plurality of candidate quality of service profiles, wherein the second quality of service correspondence table stores corresponding relationship of a plurality of candidate type of service tags and the plurality of candidate quality of service profiles.

8. A wireless communication method, comprising:
receiving a first quality of service correspondence table from a base station;
by an application layer, generating a packet, and generating a topic name of the packet and a priority order corresponding to the packet according to the packet;
by the application layer, generating a port number according to the priority order and the first quality of service correspondence table, and establishing a first setting table to store corresponding relationship between the port number and the topic name;
by a middleware layer, receiving the topic name from the application layer, and searching the corresponding port number by looking up the first setting table according to the topic name; and
by the middleware layer, establishing a first communication connection from the wireless communication device to the base station according to the port number, and transmitting the packet from the wireless communication device to the base station through the first communication connection.

9. The wireless communication method of claim 8, wherein the step of, by the application layer, generating the port number according to the priority order and the first quality of service correspondence table comprises:
by the application layer, looking up the first quality of service correspondence table according to the priority order to select the port number and a first quality of service profile which correspond to the packet.

10. The wireless communication method of claim 9, wherein the step of, by the middleware layer, establishing the first communication connection from the wireless communication device to the base station according to the port number comprises:
by the middleware layer, establishing the first communication connection from the wireless communication device to the base station through the port number, wherein the first communication connection with the port number adopts the first quality of service profile.

11. The wireless communication method of claim 8, further comprising:
by the transceiver circuit, receiving a second quality of service correspondence table from the base station;
by the application layer, generating a type of service tag according to the priority order and the second quality of service correspondence table, and establishing a second setting table to store corresponding relationship between the type of service tag, the port number, and the topic name;
by the middleware layer, receiving the topic name from the application layer, and searching the corresponding type of service tag by looking up the second setting table according to the topic name; and
by the middleware layer, establishing a second communication connection from the wireless communication device to the base station according to the type of service tag, and transmitting the packet from the wireless communication device to the base station through the second communication connection.

12. The wireless communication method of claim 11, wherein the step of, by the application layer, generating the type of service tag according to the priority order and the second quality of service correspondence table comprises:
by the application layer, looking up the second quality of service correspondence table according to the priority order to select the type of service tag and a second quality of service profile which correspond to the packet.

13. The wireless communication method of claim 11, wherein the step of, by the middleware layer, establishing the second communication connection from the wireless communication device to the base station according to the type of service tag comprises:
by the middleware layer, establishing the second communication connection from the wireless communication device to the base station through the type of service tag, wherein the second communication connection with the port number adopts the second quality of service profile.

14. The wireless communication method of claim 11, wherein the first quality of service correspondence table stores corresponding relationship between a plurality of candidate port numbers and a plurality of candidate quality of service profiles, wherein the second quality of service correspondence table stores corresponding relationship of a plurality of candidate type of service tags and the plurality of candidate quality of service profiles.
